(19) United States
(12) Patent Application Publication
(10) Pub. No.: US 2002/0111952 A1
(43) Pub. Date: Aug. 15, 2002

(54) REAL TITLE

(75) Inventors: Tsung-Wei Tu, Tainan (TW); Hung-Sheng Chiu, Taipei Hsien (TW)

Correspondence Address: DARBY & DARBY P.C., 805 Third Avenue, New York, NY, 10022, US

(73) Assignee: Institute for Information Industry

(21) Appl. No.: 09/818,741

(22) Filed: Mar. 27, 2001

(30) Foreign Application Priority Data
Dec. 18, 2000 (TW) 89127082

(51) Int. Cl. G06F 17/30; G06F 15/16; G06F 17/21

(52) U.S. Cl. 707/101; 707/10; 707/513; 709/230

(57) ABSTRACT

The present invention relates to a method transforming at least one two-dimensional data set into XML mode. The data sets are retrieved using standard ANSI SQL queries within a known data set structure, while transmitting parameters relating to the data structure, the data sets are output as a XML format.

### FIELD OF THE INVENTION

The present invention generally relates to a method transforming two dimensional data sets into a XML mode.

### DESCRIPTION OF THE RELATED ART

Computer-processed data is usually provided by one or a plurality of data sources and aggregated into a presentation format. For instance, when a user searches for data on the Internet, the data retrieved may comprise data from different files or a dynamic mix of data frames from various databases. After transforming the database into an acquired presentation form, reading software is used to display the search result (a dynamic assembly file). In general, the above-mentioned dynamic assembly file might be formatted using languages such as Extensible Markup Language (XML).

At the present, to search a master-detail data, apart from the specific queries provided by individual database servers, common SQL queries are used to represent a data set, wherein either multiple SQL queries are used to represent multiple data sets, or a single SQL query is used to represent a single data set. On the other hand, the presentation thereof is ambiguous. To transform such data into the XML format, assigning individual data layers to each of the corresponding XML is required, which is time-consuming and thus not an efficient procedure.

To solve the above-described problem, the present invention provides a multiple master-detail XML transaction method using a standard SQL query.

### SUMMARY OF THE INVENTION

Therefore, an object of the present invention is to provide a method to transform two-dimensional data sets into a XML format. At least one predetermined parameter relating to the data structure is defined in the transforming method. The method comprises the following steps:

(a) retrieving a first data set from a database.

(b) if the data set comprises a plurality of data layers, adding each subsequent data layer under its preceding data layer, and assigning XML nodes to the preceding data layers.

(c) when a second data set is found, retrieving the second data set and comparing data layers of the second data set with XML nodes of the first data set, respectively, until reaching the last XML node.

(d) if all the data layers in the second data set match with all of the XML nodes of the first data set, adding the last layer of the second data set under the last XML node of the first data set; if one of the data layer in the second data set does not match the corresponding XML node, adding that specified data layer under the last XML node matched in the comparison.

These and further features, aspects and advantages of the present invention, as well as the structure and operation of various embodiments thereof, will become readily apparent with reference to the following detailed description of a presently preferred, but nonetheless illustrative embodiment when read in conjunction with the accompanying drawings, in which like parameters indicate identical or functionally similar elements throughout the enumerated Figures.

### BRIEF DESCRIPTION OF THE DRAWINGS

The drawings referred to herein will be understood as not being drawn to scale except if specially noted, the emphasis instead being placed upon illustrating the principles of the present invention. In the accompanying drawings:

FIG. 1 is a schematic diagram of the method of the present invention of transforming a two-dimensional database of an order sheet into a XML format;

FIG. 2 shows the searched data sets;

FIGS. 3a˜3c are the schematic diagrams of the steps of the XML transforming method of the data sets of the present invention.

### DETAILED DESCRIPTION OF THE PREFERRED EMBODIMENTS

Reference is now made in detail to an embodiment of the present invention that illustrates the best mode presently contemplated by the inventor(s) for practicing the present invention. Other embodiments are also described herein. The present invention relates to a method that transform two-dimensional data sets sorted by using the standard ANSL SQL language into a XML format. The method comprises the following steps:

Firstly, sorting a first data set from a database using ANSL. Determining whether the first data set contains any subordinate data under the main data file, if there is any, assigning the upper-layered main data to a XML node and adding the subordinate data under the main data layer. Detecting subordinate data files and repeating the adding and XML node assigning procedure until the search reaches the last layer of the data set.

Next, if a second data set is found following the first data set, each data layer in the second data set is compared to the XML nodes hereinabove. The adding and XML node assigning procedure is repeated until the last XML node is appointed.

If all the data in the second data set matches the corresponding data at the XML nodes of the first data set, adding the last piece of data of the second data set under the last XML node formed at the first data set; if one of the data layers in the second data set does not match that at the corresponding XML node in the first data set, the data is added under the last XML node with the matched data.

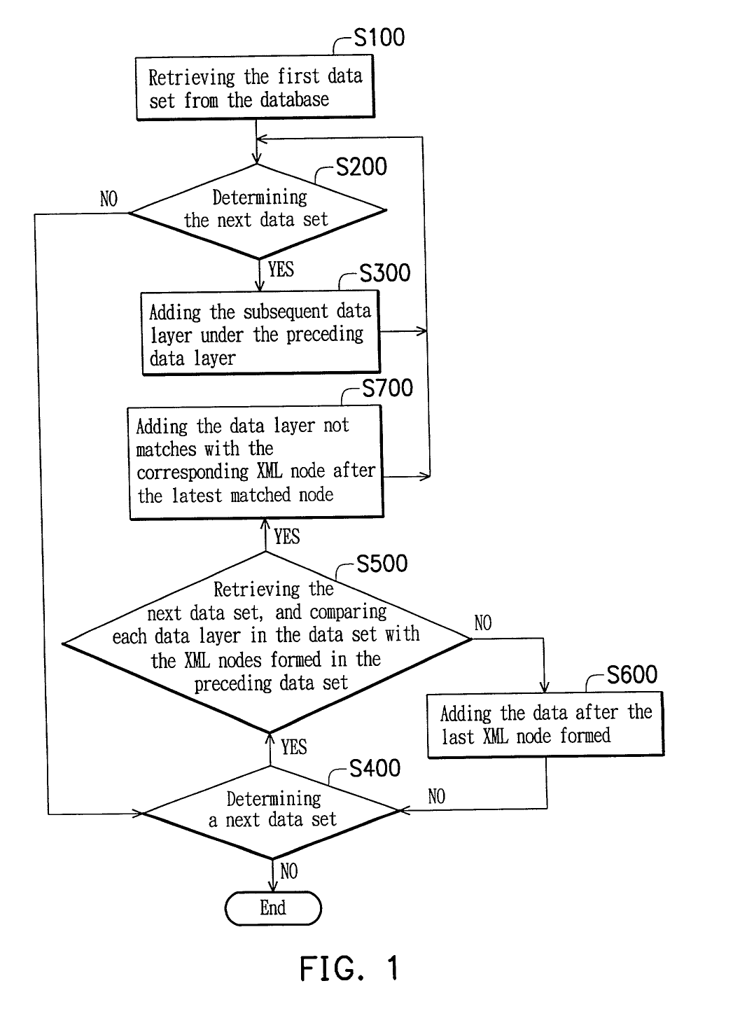

Then determining whether there is any data set following the current data set. If any, repeating all the steps hereinabove, until no subordinate data layer is detected. For purposes of illustration, a method of transforming a two-dimensional database of an order sheet into a XML format is described in FIG. 1 and below: Starting with step S100, searching a database with a standard ANSI SQL language for a main data file with file number “20000710001” and its corresponding subordinate files. Next, the search results from the data base are retrieved.

| | | Member | OrderStat | | | Product | Product |
|---|---|---|---|---|---|---|---|
| OrderNo | OrderDate | ID | us | SubTotal | ProductID | Qty | Price |
| 20000710 | 2000-07- | 20000710 | 0 | 2350 | P2000062 | 1 | 900.0000 |
| 0001 | 10 | 0002 | | | 00001 | | |
| 20000710 | 2000-07- | 20000710 | 0 | 2350 | P2000062 | 1 | 1400.000 |
| 0001 | 10 | 0002 | | | 80001 | | 0 |
| 20000710 | 2000-07- | 20000710 | 0 | 2350 | P2000070 | 1 | 50.0000 |
| 0001 | 10 | 0002 | | | 40001 | | |

The searched data in the data set contains OrderNo(order number), OrderDate, MemberID, OrderStatus, Sub Total (product total), ProductID, ProductQty (ProductQuantity) and ProductPrice, as shown in Table 1.

The transforming method of the present invention involves transmitting a number of specified parameters. The parameters relating to the data structure is illustrated as follows:

(1) LEVEL1 represents the XML levels, for example: 1—[Master], 2—[Master-Detail1 ], 3—[Master-Detail2]. . . etc. The present invention only contains a main file and a subordinate data file, so LEVEL1 is 2.

(2) DataAlias[n] is the file name of the [n]th data layer in the data set. The present invention contains two data layers in each data set, DataAlias0 (the 0th data layer) is the main order information (OrderMainInfo), and DataAlias1 (the 1^{st} data layer) is the detail order information (OrderDetailInfo).

(3) DataKey[n] is the field connecting the [n]th layer and the [n+1]th data layer. If the LEVEL1 is 1, this DataKey can be omitted. The LEVEL1 of the present invention is 2, so the Datakey between the 0^{th} layer and the 1^{st} layer is the order number 200007100001.

(4) DataShema[n] is the field subjected to feedback in the [n]th data layer. If no DataScheme is assigned, the resulting XML then contains all the data in the field defined by the SQL query, which is the case in the present invention. The DataScheme[0] of the present invention contains OrderNo, OrderDate, Member ID, SubTotal, and OrderStatus, and the DataScheme[1] contains ProductID, ProductQty, and ProductPrice.

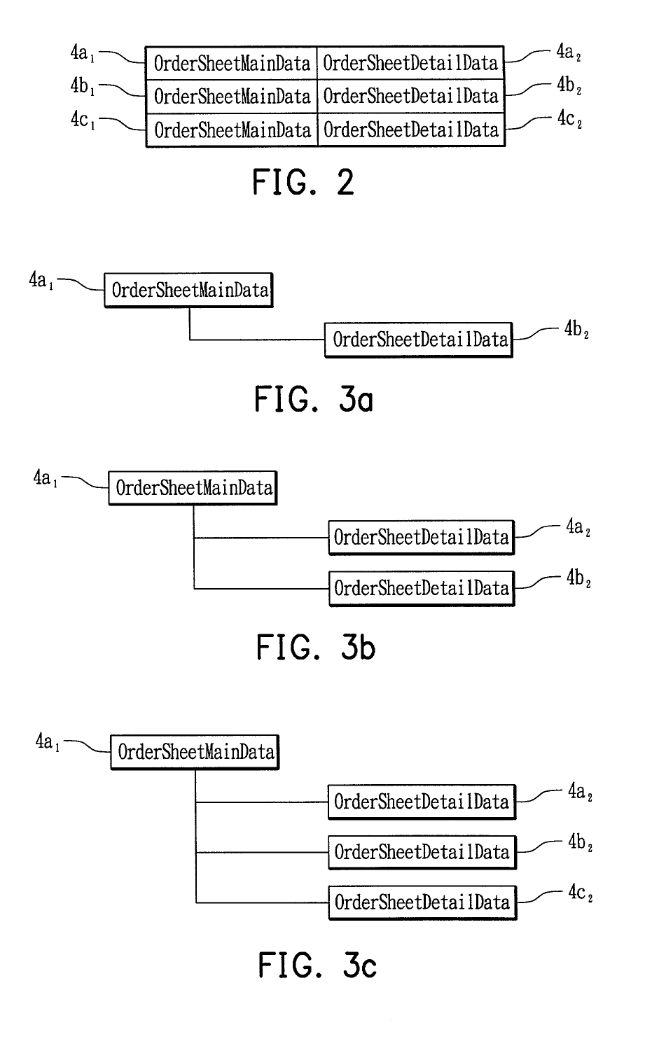

The structural transformation of the datasets involves transmission of the parameters described hereinabove. FIG. 2 shows the searched data sets, wherein 4a₁ represents the main order information (OrderMainInfo), the 0^{th} layer of the data set, 4a₂ represents the detail order information (OrderDetailInfo), the 1^{st} layer of the dataset.

After retrieving the data sets searched from the order sheet database, in step S200, it is determined whether or not there is a 1^{st} layer under the 0^{th layer} of the first data set. If no subordinate layer is found, the procedure skips to step S400 to detect the next data set. In this case, a subordinate layer 4b(the 1^{st} layer) is found under the 0^{th} layer. So, in step S300, adding the data of the 1^{st} layer under that of the 0^{th} layer, and the 0^{th} layer appointed a XML node, as shown in FIG. 3a. The procedure is repeated until the search reaches the last layer of the data set before starting the search for the next data set.

In step S400, it is determined whether or not there is second data set. If a positive search occurs, following Step S500 to retrieve the second data set.

In step S500, the OrderNo of the second data set is compared to the OrderNo of the XML node of the first data set. In this case, both have the same OrderNo of 20007100001, but different Product ID, with that of the first data set being P200006200001, and of the second data set being P200006280001.

In step S700, the 1^{st} layer of the second data set shown as 4b₂ in FIG. 2, is added after the XML node of the 0^{th} layer of the first data set as shown in FIG. 3b. Then, it is determined whether or not a subordinate layer exists under current data layer. In the case of the present invention, there is no 2^{nd} data layer, so forwarding to step S400 to detect the next piece of data. If a following data set is detected as the case, the procedure is forwarded to step S500 to retrieve the detected data set. Then, the OrderNo of the third data set is compared to the OrderNo of the XML node of the first data set. In this case, both have the same OrderNo of 20007100001, but different Product ID, with that of the first data set being P200006200001, and the second data set being P200007040001. So step 700 is carried out to add the 1^{st} layer of the third set of data 4b₂ in FIG. 2 under the XML node of the 0ₜₕ layer of the first data set as shown in FIG. 3c. Then, proceeding with step S200 to determine whether or not a next data set layer exists. In this case, no subsequent data set is found, so the procedure ends.

The transformed XML data has the following format:

<NewPlatform>

<OrderMainlnfo>

<OrderNo>200007100001</OrderNo>

<OrderDate>2000-07-10</OrderDate>

<MemberID>200007100002</MemberID>

<OrderStatus>0</OrderStatus>

<SubTotal>2350</SubTotal>

<OrderDetailInfo>

<ProductID>P200006200001</ProductID>

<ProductQty>1<ProductQty>

<ProductPrice>900.0000</ProductPrice>

<OrderDetailInfo>

<OrderDetailInfo>

<ProductID>P200006280001</ProductID>

<ProductQty>1</ProductQty>

<ProductPrice>1400.0000</ProductPrice>

</OrderDetailInfo>

<OrderDetailInfo>

<ProductID>P200007040001</ProductID>

<ProductQty>1</ProductQty>

<ProductPrice>50.0000</ProductPrice>

</OrderDetailInfo>

</OrderMainInfo>

<NewPlatform>

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Similarly, any process steps described herein may be interchangeable with other steps in order to achieve the same result. Therefore, the scope of the appended claims should be accorded the broadest interpretation so as to encompass all such modifications and similar arrangements, which is defined by the following claims and their equivalents.

What is claimed is:

1. A method of transforming a plurality of two dimensional data sets into a XML format, involving defining at least one predetermined parameter, the method comprises the following steps:
(a) retrieving a first data set from a database,
(b) if the data set comprises a plurality of data layers, adding each subsequent data layer under its preceding data layer, and assigning XML nodes to the preceding data layers,
(c) when a second data set is found, retrieving the second data set and comparing data layers of the second data set with XML nodes of the first data set respectively until reaching the last XML node, and
(d) if all the data layers in the second data set match with all of the XML nodes of the first data set, adding the last layer of the second data set under the last XML node of the first data set; if one of the data layers in the second data set does not match the corresponding XML node, adding that specified data layer under the last XML node matched in the comparison.

2. As the transformation method as claimed in claim 1,
wherein the parameters comprises:
a XML layer number, representing the number of layers in the data set;
a plurality of Data names of the [n]th data layer;
a plurality of Connect fields between the [n]th data layer and the [n+1]th data layer, the key to compare the data
layer in the data set with a corresponding data layer of a different data set;
Fields subjected to being output in the [n]th data layer, after the transformation.

3. The transforming method as claimed in claim 1, wherein, a display unit is provided to display the transformed XML format.

4. The transforming method as claimed in claim 1, wherein the two dimensional data sets are commercial mode data.
